(19) United States
(12) Patent Application Publication
(10) Pub. No.: US 2022/0308890 A1
(43) Pub. Date: Sep. 29, 2022

(54) MULTI-PROCESSING UNIT INTERCONNECTED ACCELERATOR SYSTEMS AND CONFIGURATION TECHNIQUES

(71) Applicant: Alibaba Singapore Holding Private Limited, Singapore (SG)

(72) Inventor: Liang HAN, Campbell, CA (US)

(21) Appl. No.: 17/216,189

(22) Filed: Mar. 29, 2021

(51) Int. Cl. G06F 9/38; G06F 9/50; G06N 3/063; G06N 3/04

(52) U.S. Cl. CPC G06F 9/3891; G06F 9/5077; G06N 3/063; G06N 3/04; G06F 2209/505

(57) ABSTRACT

A compute system providing hierarchical scaling can include one or more sets of parallel processing units. The parallel processing units in a set can be organized into subsets of parallel processing units. Each parallel processing unit can be configurably couplable to two nearest neighbor parallel processing units in a same subset by two communication links, and each parallel processing unit can be configurably couplable to farthest neighbor parallel processing unit in the same subset by one communication link. Furthermore, each parallel processing unit can be configurably couplable to a corresponding parallel processing unit in the other subset by two communication links. The compute system can be configured by configuring the communication links of a set of parallel processing units into one or more compute clusters including a corresponding number of communication rings based on a specified compute parameter. Input data for computing on a given compute cluster divided and loaded onto respective parallel processing units of the given compute cluster. A function can be computed on the loaded input data by the given compute cluster using a parallel communication ring algorithm of the function.

### BACKGROUND OF THE INVENTION

A current methodology for parallel/distributed training of deep neural networks includes applying synchronized large minibatch stochastic gradient descent (SDG) processing on many distributed computing nodes to explore data parallel based acceleration.

Referring to FIG. 1, an exemplary minibatch SDG process, including pseudo code, for running on a CPU host is illustrated. The process is subject to the synchronization parts bottlenecking the whole process of parallel acceleration. To reduce bottlenecking, building up the bandwidth of an accelerator-side network and/or reducing the frequency of host accelerator communication is needed, as illustrated in FIG. 2.

There are a number of algorithms for the synchronization of minibatch SDG processing. Some common inter-computing-note communication mode functions are the Reduce and All_Reduce functions. Referring now to FIG. 3, the Reduce function is illustrated. In the Reduce function, a set of values of each of a plurality nodes 310-340 are passed to a given one 310 of the plurality of nodes 310-340, which adds the respective values together. The sum of the set of values is stored by the given node 310. For example, a first node 310 receives the values of 5, 2, 7 and 4 from the plurality of nodes 310-340, the first node adds the received values of 5, 2, 7 and 4 together, and the first node 310 stores the resulting sum of 18. The first node 310 also adds the values of 1, 3, 8 and 2 together and stores the resulting sum of 14. Referring now to FIG. 4, the All-Reduction function is illustrated. In the All_Reduce function, a set of values of each of a plurality of nodes 410-440 are passed to a given one 410 of the plurality of nodes 410-440, which adds the respective values together. The set of sum values is broadcast by the given node 410 to the plurality of nodes 410-440, and the plurality of nodes 410-440 store the set of sum values. For example, a first node 410 adds the values of 5, 2, 7 and 4 received from the plurality of nodes 410-440 together. The first node 410 also adds the values of 1, 3, 8 and 2 together. The first node 410 broadcast the set of sum values of 18 and 14 to the plurality of nodes 410-440, which each store the set of sum values. As illustrated, the Reduce function and All_Reduce function are applied to a bunch of variables simultaneously.

Although a straightforward topology implementation of the Reduce and All_Reduce functions is a tree-based implementation, ring-based implementation can achieve a higher bandwidth utilization rate and efficiency. Referring now to FIG. 5, a conventional ring-based All_Reduce implementation on a distributed computing system is illustrated. In the All_Reduce function, each of N nodes of a distributed computing system communicate with two of its peer nodes 2*(N−1) times. During the communications, a node sends and receives set of values. In the first N−1 iterations, received values are added to the values in the respective nodes' buffers. In the second N−1 iterations, received values replace the values held in the respective nodes' buffers. For example, FIG. 5. illustrates three nodes (N=3) 510 each buffering a respective set of input values. In a first iteration 520, the first node passes a first set of input values to a second node. The second node adds the set of input values received from the first node to corresponding input values held by the second node. The first node also receives a third set of input values from a third node. The first node adds the set of input values received from the third node to corresponding values held by the first node. The second and third nodes also pass and add corresponding sets of input values in the first iteration 520. In a second iteration 530, the first node passes a third set of input values to the second node, which the second node adds to corresponding values held by the second node. The first node also receives a second set of values from the third node, which the first node adds to corresponding values held by the first node. The second and third nodes again pass and add corresponding sets of values in the second iteration 530. In a third iteration 540, the first node passes a second set of sum values to the second node, which the second node stores. The first node also receives a first set of sum values from the third node, which the first node stores. The second and third nodes also pass and store corresponding sets of the sum values. In a fourth iteration 550, the first node passes a first set of sum values to the second node, which the second node stores. The first node also received a third set of the sum values from the third node, which the first node stores. The second and third nodes also pass and store corresponding sets of the sum values. After the fourth iteration, each node has the set of sum values. If the buffer is large enough, the ring-based All_Reduce function illustrated in FIG. 5 can optimally utilize the available network of a distributed computing system.

However, there is a need for an improved chip-to-chip high-speed serial/deserialization (SerDes) interconnection so that such a distributed system for computing the All_Reduce function can be implemented within a cluster of chips instead of on distributed computers connected via slower ethernet, infiniband or the like communication links.

### SUMMARY OF THE INVENTION

The present technology may best be understood by referring to the following description and accompanying drawings that are used to illustrate embodiments of the present technology directed toward multi-processing unit interconnected accelerator systems and configuration techniques thereof.

In one embodiment, a compute system can include one or more sets of parallel processing units. The parallel processing units in a set can be organized into subsets of parallel processing units. Each parallel processing unit can be configurably couplable to two nearest neighbor parallel processing units in a same subset by two communication links, and each parallel processing unit can be configurably couplable to a farthest neighbor parallel processing unit in the same subset by one communication link. Furthermore, each parallel processing unit can be configurably couplable to a corresponding parallel processing unit in the other subset by two communication links.

In another embodiment, a compute method can include configuring communication links of a set of parallel processing units into one or more compute clusters including a corresponding number of communication rings based on a specified compute parameter. A function can be computed on input data by the one or more compute clusters using a parallel communication ring algorithm. The function can be, but is not limited to, a Reduce function or a All_Reduce function.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows an exemplary minibatch SDG process according to the conventional art.

FIG. 2 shows another exemplary minibatch SDG process according to the conventional art.

FIG. 3 illustrates computation of a Reduce function according to the conventional art.

FIG. 4 illustrates computation of an All_Reduce function according to the conventional art.

FIG. 5 illustrates computation of a ring All_Reduce algorithm according to the conventional art.

FIG. 6 shows a plurality of parallel processing units (PPUs) providing for hierarchical scaling, in accordance with aspects of the present technology.

FIG. 7 illustrates a hierarchical scaling configuration of a plurality of PPUs, in accordance with aspects of the present technology.

FIG. 8 shows a method of hierarchical scaling of a plurality of PPUs, in accordance with aspects of the present technology.

FIG. 9A illustrates a hierarchical scaling configuration of a plurality of PPUs, in accordance with aspects of the present technology.

FIG. 9B illustrates a hierarchical scaling configuration of a plurality of PPUs, in accordance with aspects of the present technology.

FIG. 9C illustrates a hierarchical scaling configuration of a plurality of PPUs, in accordance with aspects of the present technology.

FIG. 10 illustrates a hierarchical scaling configuration of a plurality of PPUs, in accordance with aspects of the present technology.

FIG. 11 illustrates a hierarchical scaling configuration of a plurality of PPUs, in accordance with aspects of the present technology.

FIG. 12 shows an exemplary computing system include a plurality of PPUs, in accordance with aspects of the present technology.

FIG. 13 shows an exemplary PPU, in accordance with aspects of the present technology.

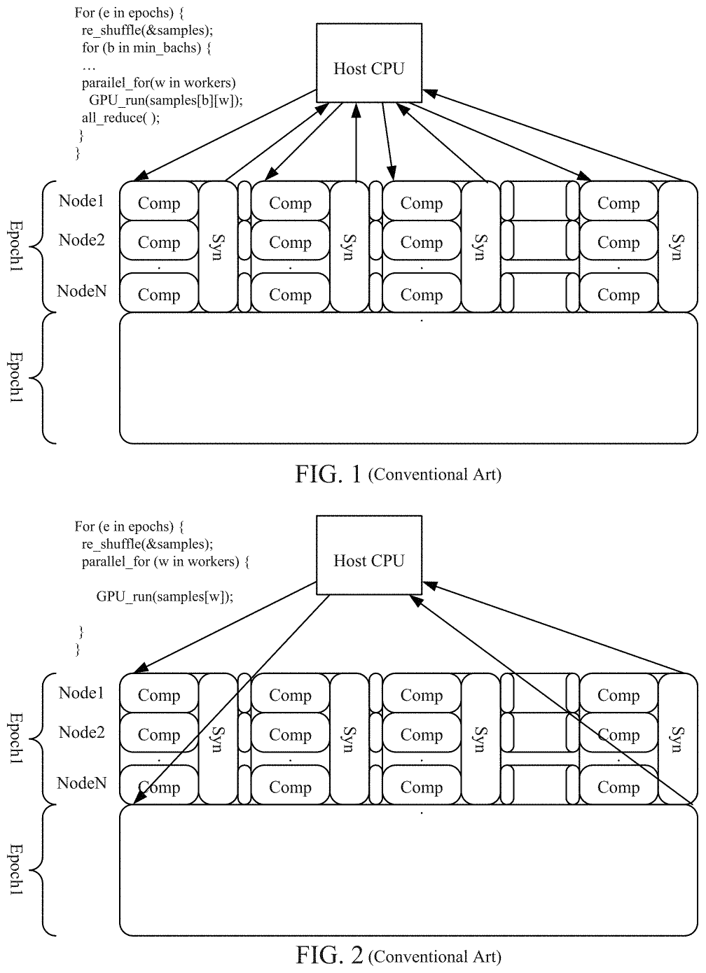

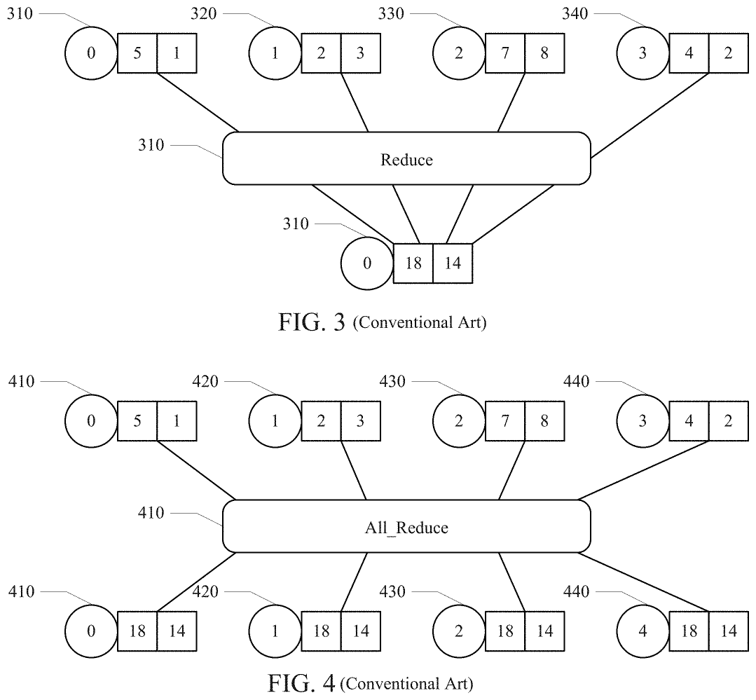

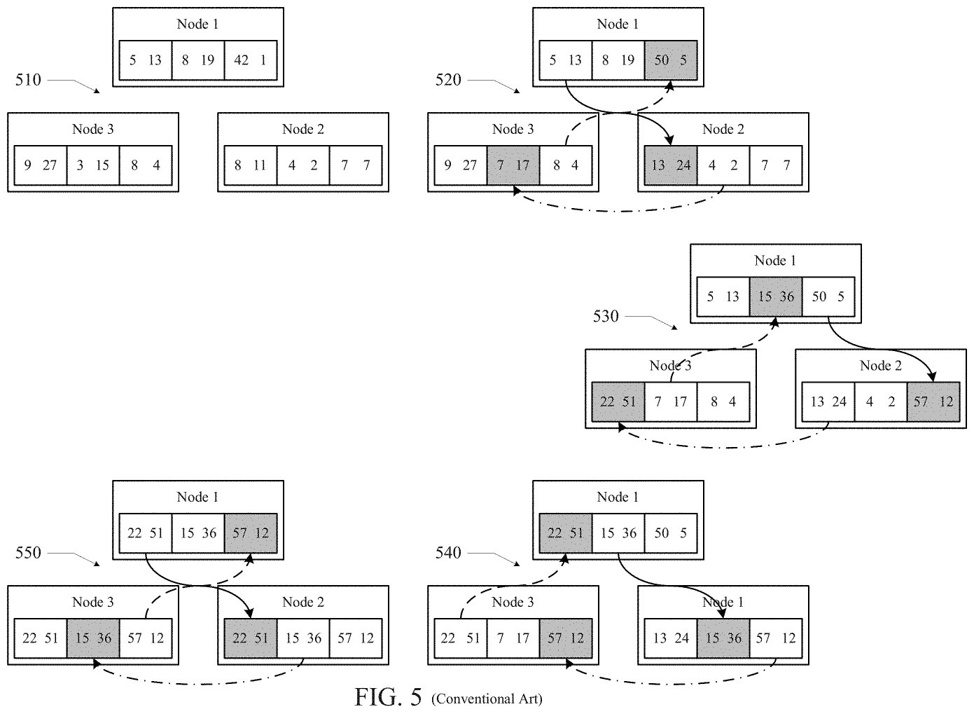

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the technology to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that these terms are to be interpreted as referencing physical manipulations and quantities and are merely convenient labels and are to be interpreted further in view of terms commonly used in the art. Unless specifically stated otherwise as apparent from the following discussion, it is understood that through discussions of the present technology, discussions utilizing the terms such as “receiving,” and/or the like, refer to the actions and processes of an electronic device such as an electronic computing device that manipulates and transforms data. The data is represented as physical (e.g., electronic) quantities within the electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. The use of the terms “comprises,” “comprising,” “includes,” “including” and the like specify the presence of stated elements, but do not preclude the presence or addition of one or more other elements and or groups thereof. It is also to be understood that although the terms first, second, etc. may be used herein to describe various elements, such elements should not be limited by these terms. These terms are used herein to distinguish one element from another. For example, a first element could be termed a second element, and similarly a second element could be termed a first element, without departing from the scope of embodiments. It is also to be understood that when an element is referred to as being “coupled” to another element, it may be directly or indirectly connected to the other element, or an intervening element may be present. In contrast, when an element is referred to as being “directly connected” to another element, there are not intervening elements present. It is also to be understood that the term “and or” includes any and all combinations of one or more of the associated elements. It is also to be understood that the phraseology and terminology used herein is for the purpose of description and should not be regarded as limiting.

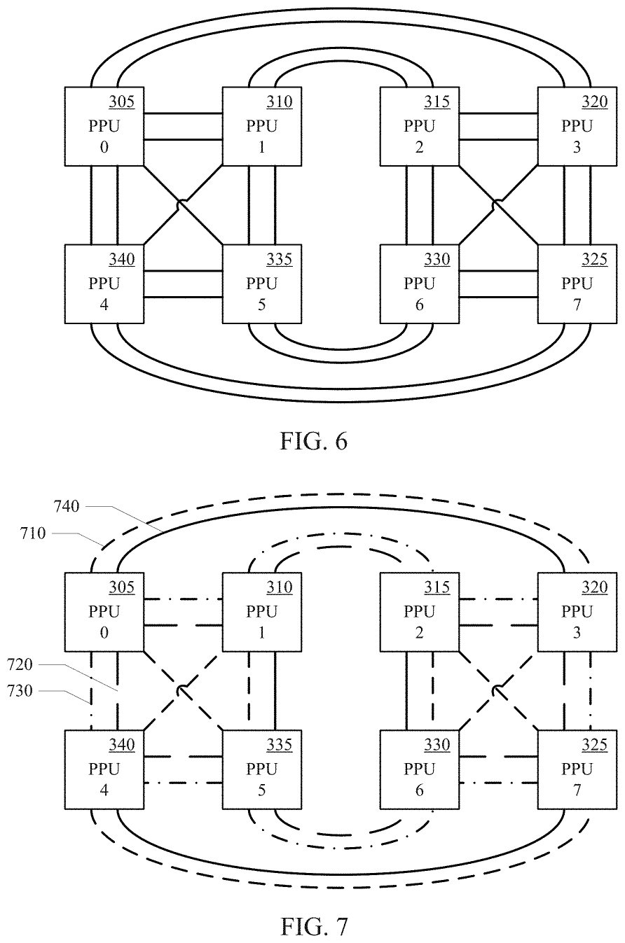

Referring now to FIG. 6, a plurality of parallel processing units (PPUs) providing for hierarchical scaling, in accordance with aspects of the present technology, is shown. The plurality of PPUs can include one or more sets of eight PPUs Each PPU can include seven communication ports. The eight PPUs in a set can be organized in a first subset of four PPUs and a second subset of four PPUs. Each PPU can be configurably couplable to two nearest neighbor PPUs in a same subset by two communication links. Each PPU can also be configurably couplable to a farthest neighbor PPU in the same subset by one communication link. Each PPU can also be configurably couplable to a corresponding PPU in the other subset by two communication links. In one implementation, the PPUs can be coupled by configurable bi-directional communication links. The configurably couplable communications links can be configured as up to three communication rings 710-730 coupling eight PPUs together, as illustrated in FIG. 7. For example, a first bi-directional ring illustrated by the dashed lines 710 can communicatively link the first PPU 305 to the fourth PPU 320, the fourth PPU 320 to the fifth PPU 330, the fifth PPU 330 to the third PPU 315, the third PPU 315 to the eighth PPU 325, the eighth PPU 325 to the fifth PPU 340, the fifth PPU 340 to the second PPU 310, the second PPU 310 to the sixth PPU 335, and the sixth PPU 335 back to the first PU 305. There is also some communication links 740 in addition to the three communication rings 710-730, as represented by the solid lines. It is appreciated that the communication rings 710-730 are just an exemplary set of three communication rings that can be configured from the communication links between the sets of nearest neighbors of PPUs in each subset, one bi-directional communication link between each set of farthest neighbors of PPUs in each subset, and two bi-directional communication links between corresponding PPUs of the two subsets of PPUs

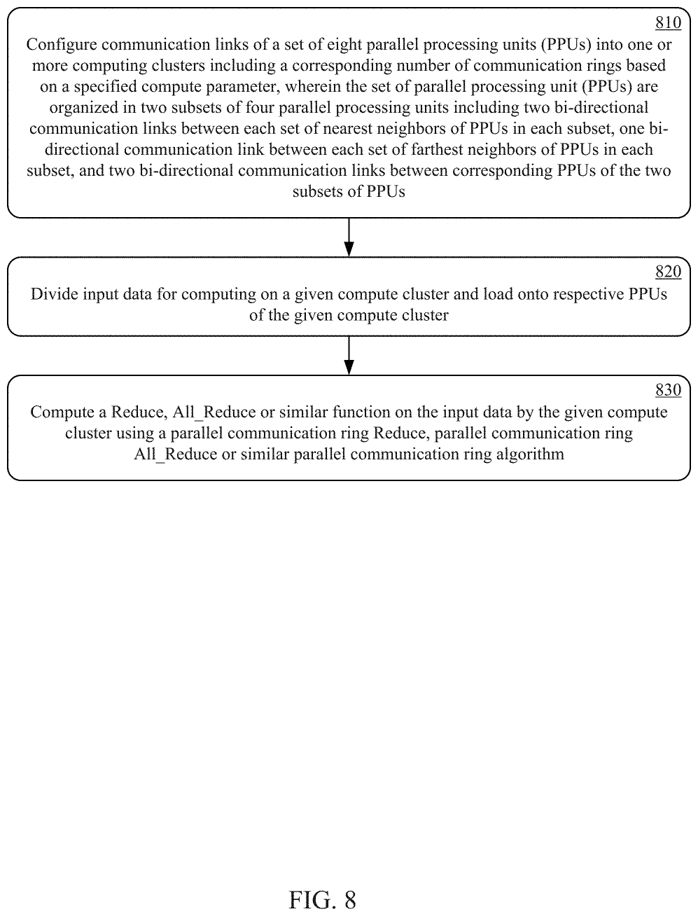

The hierarchical scaling of the PPUs will be further explained with reference to FIG. 8. The communication links of the set of eight PPUs can be configured into one or more compute clusters including a corresponding number of communication rings based on a specified compute parameter, at 810. In one implementation, the compute parameter can be a number of PPUs for a given compute cluster, such as eight, four or two PPUs for the given compute cluster. In another implementation, the compute parameter can be an amount of compute processing bandwidth. The compute processing bandwidth can be mapped to a given number of PPUs. In one implementation, the eight PPUs can be configured as one cluster of eight PPUs communicatively coupled by three bi-directional communication rings, as illustrated in FIG. 7. In other cases, an application may not need a cluster of eight PPUs to compute Reduce, All_Reduce or other similar functions. In yet other cases, such as cloud compute services, a customer may want to choose whether to pay for the compute processing bandwidth of eight, four or two PPUs.

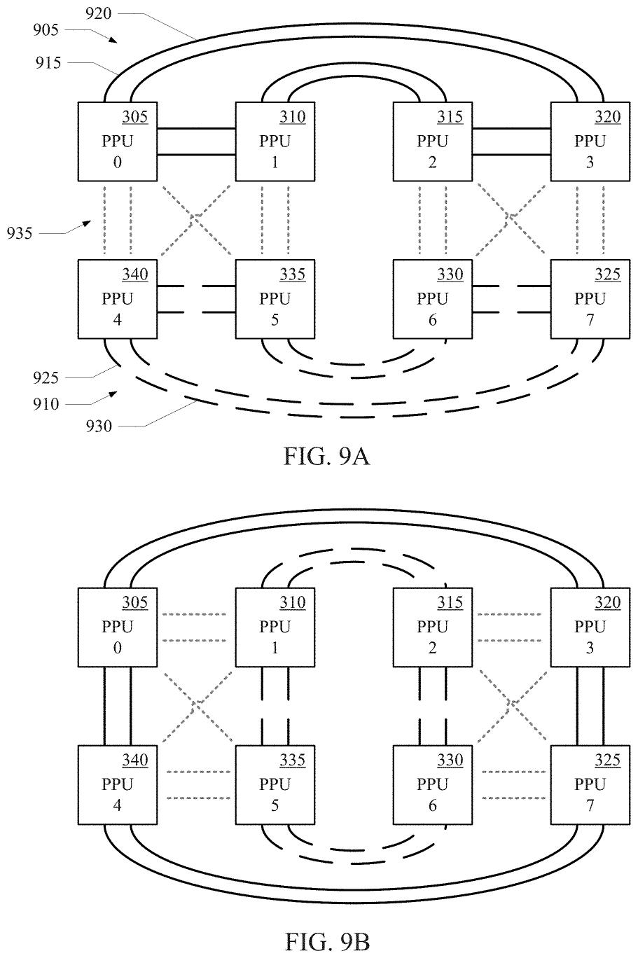

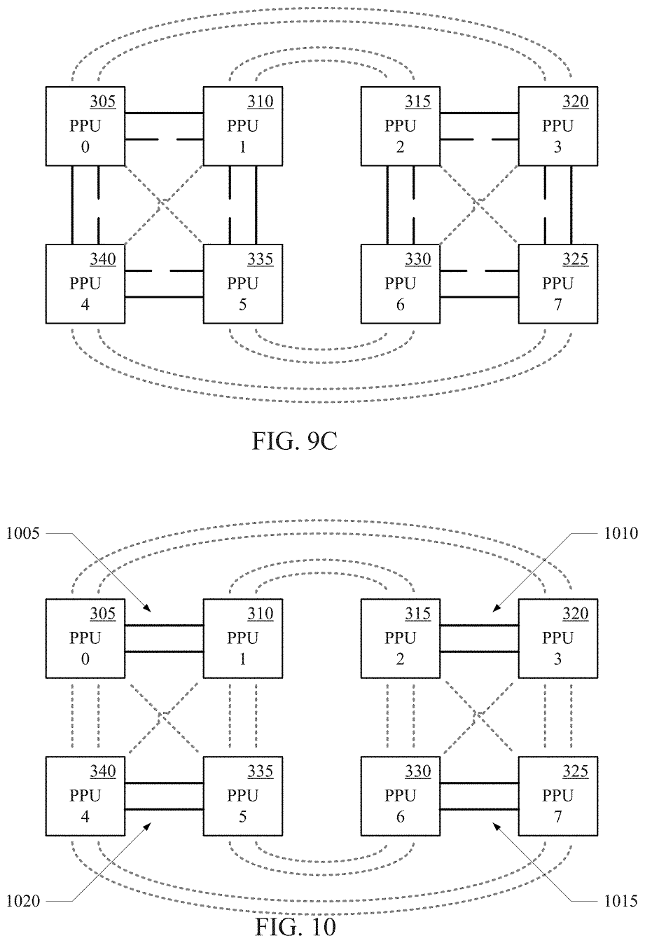

Accordingly, in another implementation, the eight PPUs can be configured as two compute clusters 905, 910 of four PPUs 305-320, 325-340 each, as illustrated in FIG. 9A. The communication links can be configured by enabling a given subset of the communication links and disabling the other communications links such that the PPUs in each compute cluster 905, 910 are communicatively coupled by two bi-directional communication rings 915-920, 925-930. For example, a first 915 and second 920 bi-directional ring can couple the first PPU 305 to the fourth PPU 320, the fourth PPU 320 to the third PPU 315, the third PPU 315 to the second PPU 310, and the second PPU 310 to the first PPU 305. Similarly, a third 925 and fourth 930 bi-directional ring can couple the fifth PPU 340 to the sixth PPU 335, the sixth PPU 325 to the seventh PPU 330, the seventh PPU 330 to the eighth PPU 325, and the eighth PPU 325 to the fifth PPU 340. The other communication links 935 can be disabled or utilized for other purposes. With two bi-direction communication rings, each compute cluster of four PPUs can be configured to compute different Reduce, All_Reduce or the like functions. The exemplary configuration illustrated in FIG. 9A is just one possible configuration of the eight PPUs into two compute clusters of four PPUs. Other possible configurations of the eight PPUs into two compute cluster of four PPUs are illustrated in FIGS. 9B and 9C.

In yet other implementations, the eight PPUs can be configured as four compute clusters of 1005, 1010, 1015, 1020 of two PPUs 305-310, 315-320, 325-330, 335-340, as illustrated in FIG. 10. The PPUs in each compute cluster 1005, 1010, 1015, 1020 can be communicatively coupled by a respective bi-directional communication ring. For example, the first PPU 305 can be coupled to the second PPU 310 by first and second bi-directional communication links. The other communication links can be disabled or utilized for other purposes. Each compute cluster 1050, 1010, 1015, 1020 of two PPUs can be configured to compute different Reduce, All_Reduce or the like functions. Again, the exemplary configuration illustrated in FIG. 10 is just one possible configuration of the eight PPUs into four compute clusters of two PPUs.

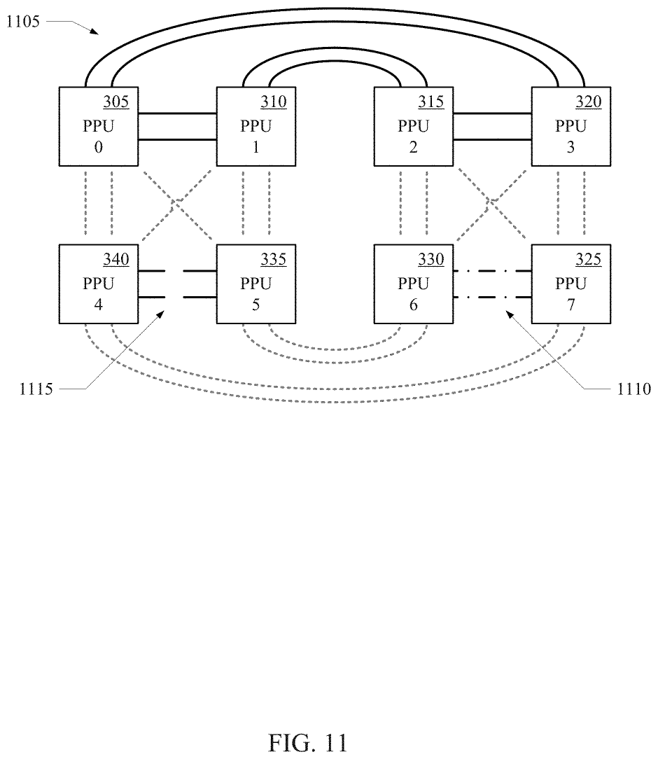

In yet other implementations, the eight PPUs can be configured as a combination of one compute cluster 1105 of four PPUs 305-320, and two compute clusters 1110, 1115 of two PPUs 325-330, 335-340, as illustrated in FIG. 11. Again, each compute cluster can be configured to compute different Reduce, All_Reduce or the like functions. In addition, the exemplary configuration illustrated in FIG. 11 is just one possible configuration of the eight PPUs into one compute cluster of four PPUs, and two compute cluster of two PPUs.

Referring again to FIG. 8, input data can be divided for computing on a given compute cluster and loaded onto respective PPUs of the given compute cluster, at 820. For a compute cluster of eight PPUs coupled by three bi-directional communication rings, input data for a Reduce, All_Reduce or similar function can be divided into six groups, three groups for propagation in a first direction on the three parallel rings of bi-directional communication links and three groups for propagation in a second direction on the three parallel rings of the bi-directional communication links. For a compute cluster of four PPUs coupled by two bi-directional communication rings, the input data for the Reduce, All_Reduce or similar function can be divided into four groups, two groups for propagation in a first direction on the two parallel rings of bi-directional communication links and two groups for propagation in a second direction on the two parallel rings of the bi-directional communication links. For a compute cluster of two PPUs coupled by two bi-directional communication links, the input data for the Reduce, All_Reduce or similar function can be divided into two groups, one group for propagation in a first direction on the two bi-directional communication links and one group for propagation in a second direction on the two bi-directional communication links.

At 830, the Reduce, All_Reduce or similar function can be computed on the input data by the given compute cluster using a parallel ring Reduce, All_Reduce or similar parallel ring algorithm. In a parallel ring algorithm, each of the plurality of PPUs (e.g., N nodes) communicates with its two nearest neighbor PPUs 2*(N−1) times, exchanging a respective group on a respective ring in a respective direction. In the first N−1 iterations, a given PPU sends respective values on respective rings to its nearest neighbors. In the first N−1 iterations, the given PPU also receives respective values on respective rings from its nearest neighbors, and adds the received values to respective values in the given PPU's buffer. In the second N−1 iterations, the given PPU sends respective values on respective rings to its nearest neighbors. In the second N−1 iterations, the given PPU also receives respective values on respective rings from its nearest neighbors, and replaces the respective values in the given PPU's buffer with the respective received values.

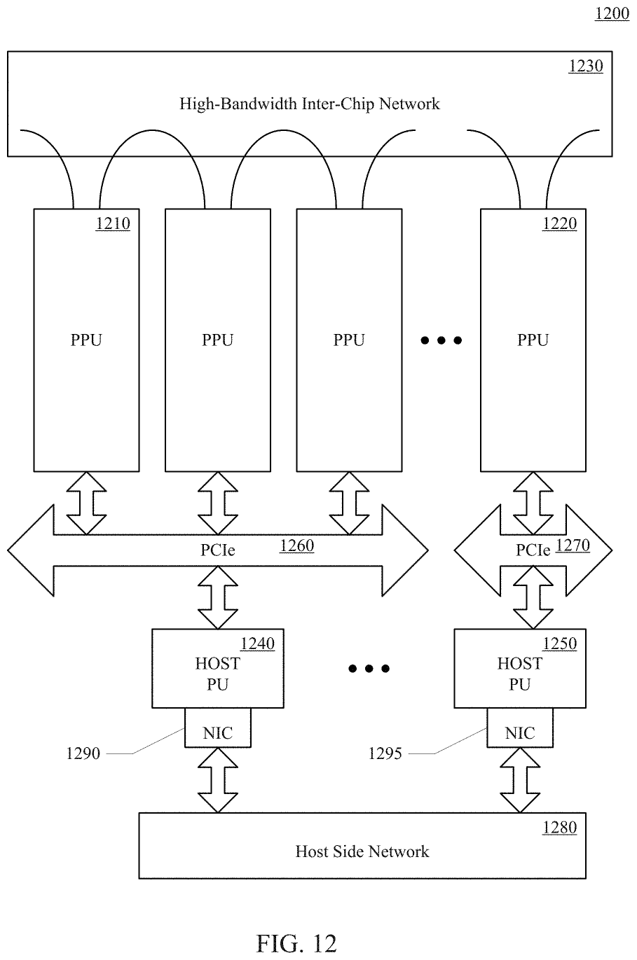

Referring now to FIG. 12, an exemplary computing system including a plurality of parallel processing units (PPUs), in accordance with aspects of the present technology, is shown. The exemplary computer system 1200 can include a plurality of parallel processing units (PPUs) 1210, 1220 coupled together by one or more high-bandwidth inter-chip networks 1230. The plurality of PPUs 1210, 1220 can be, but are not limited to, a plurality of neural processing accelerators. The PPUs 1210-1220 can also be coupled to a plurality of host processing units 1240, 1250 by one or more communication busses 1260, 1270. The one or more communications busses 1260, 1270 can be, but are not limited to, one or more peripheral component interface express (PCIe) busses. The one or more host processing units 1240, 1250 can be coupled to one or more host side networks 1280 by one or more network interface cards (NICs) 1290, 1295.

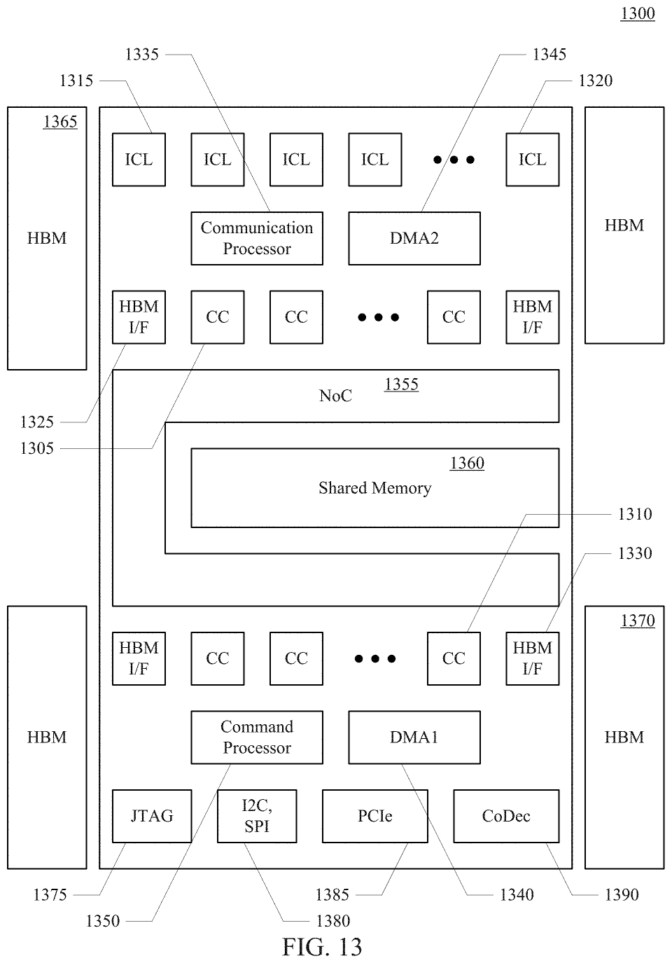

Referring now to FIG. 13, an exemplary parallel processing unit (PPU), in accordance with aspects of the present technology, is shown. The PPU 1300 can include a plurality of compute cores 1305, 1310, a plurality of inter-chip links (ICL) 1315, 1320, one or more high-bandwidth memory interfaces (HBM I/F) 1325, 1330, one or more communication processors 1335, one or more direct memory access (DMA) controllers 1340, 1345, one or more command processors (CP) 1350, one or more networks-on-chips (NoCs) 1355, shared memory 1360, and one or more high-bandwidth memory (HBM) 1365, 1370.

The PPU 1300 can also include one or more joint test action group (JTAG) engines 1375, one or more inter-integrated circuit (I²C) interfaces and or serial peripheral interfaces (SPI) 1380, one or more peripheral component interface express (PCIe) interfaces 1385, one or more codecs (CoDec) 1390, and the like. In one implementation, the plurality of compute cores 1305, 1310, the plurality of inter-chip links (ICL) 1315, 1320, one or more high-bandwidth memory interfaces (HBM I/F) 1325, 1330, one or more communication processors 1335, one or more direct memory access (DMA) controllers 1340, 1345, one or more command processors (CP) 1350, one or more networks-on-chips (NoCs) 1355, shared memory 1360, one or more high-bandwidth memory (HBM) 1365, 1370, one or more joint test action group (JTAG) engines 1375, one or more inter-integrated circuit (1²C) interfaces and or serial peripheral interfaces (SPI) 1380, one or more peripheral component interface express (PCIe) interfaces 1385, one or more codecs (CoDec) 1390, and the like can be fabricated in one monolithic integrated circuits (ICs)

The ICLs 1315, 1320 can be configured for chip-to-chip communication between a plurality of PPUs. In one implementation, the PPU 1300 can include seven ICLs 1315, 1320. The communication processor 1335 and direct memory access engines 1340, 1345 can be configured to coordinate data sent and received through the ICLs 1315, 1320. The network-on-chip (NoC) 1355 can be configured to coordinate data movement between the compute cores 1305, 1310 and the shared memory 1360. The communication processor 1335, direct memory access engines 1340, 1345, network on chip 1355 and high-bandwidth memory interfaces (HBM I/F) 1325, 1330 can be configured to coordinate movement of data between the high-bandwidth memory 1365, 1370, the shared memory 1360 and the ICLs 1315, 1320. The command processor 1350 can be configured to serve as an interface between the PPU 1300 and one or more host processing units. The plurality of the PPUs 1300 can advantageously employed to compute a Reduce, All_Reduce or other similar functions as described above with reference to FIGS. 7, 8, 9A-9C, 10 and 11.

In accordance with aspects of the present technology, hierarchical enables a plurality of PPUs to be configured as one or more compute clusters coupled by a corresponding number of parallel communication rings. Hierarchical scaling the plurality of PPUs can be advantageous when an application requires a smaller portion of the computational resources of the plurality of PPUs than can be serviced by a compute cluster of a subset of the plurality of PPUs. Likewise, hierarchical scaling can be advantageously employed in a cloud computing platform to readily enable clients to purchase the computing bandwidth of a cluster of the PPUs instead of the entire plurality of PPUs.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. A compute system comprising:
one or more sets of parallel processing units, wherein the parallel processing units in a set are organized into subsets of parallel processing units, each parallel processing unit is configurably couplable to two nearest neighbor parallel processing units in a same subset by two communication links, each parallel processing unit is configurably couplable to farthest neighbor parallel processing unit in the same subset by one communication link, and each parallel processing unit is configurably couplable to a corresponding parallel processing unit in the other subset by two communication links.

2. The compute system of claim 1, wherein the communication links comprise bi-directional communication links.

3. The compute system of claim 1, wherein the communication links of a given set of parallel processing units are configured into one or more compute clusters including a corresponding number of communication rings based on a specified compute parameter.

4. The compute system of claim 3, wherein each of the one or more compute clusters are configured to compute a corresponding Reduce or All_Reduce function on corresponding input data using a parallel ring Reduce or All_Reduce algorithm

5. The compute system of claim 3, wherein the specified compute parameter comprises a number of parallel processing units of a given compute cluster.

6. The compute system of claim 3, wherein the specified compute parameter comprises an amount of compute processing bandwidth.

7. The compute system of claim 1, wherein the one or more sets of parallel processing units comprises one or more sets of eight parallel processing units, wherein the parallel processing units in a set are organized in two subsets of four parallel processing units, each parallel processing unit is configurably couplable to two nearest neighbor parallel processing units in a same subset by two communication links, each parallel processing unit is configurably couplable to a farthest neighbor parallel processing unit in the same subset by one communication link, and each parallel processing unit is configurably couplable to a corresponding parallel processing unit in the other subset by two communication links.

8. The compute system of claim 7, wherein a given set of eight parallel processing units are configured into one compute cluster wherein the eight parallel processing units are coupled by three communication rings.

9. The compute system of claim 7, wherein a given set of eight parallel processing units are configured into two compute clusters of four parallel processing units, and the four parallel processing units of each compute cluster are coupled by two communication rings.

10. The compute system of claim 7, wherein a given set of eight parallel processing units are configured into four compute clusters of two parallel processing units, and the two parallel processing unit of each compute cluster are coupled together by one communication ring.

11. The compute system of claim 7, wherein a given set of eight parallel processing units are configured into one compute cluster of four parallel processing units and two compute clusters of two parallel processing units, the four parallel processing units of the compute cluster of four parallel processing units are coupled by two communication rings, and the two parallel processing unit of each of the compute clusters of two parallel processing units are coupled together by a respective communication ring.

12. A compute method comprising:
configuring communication links of a set of parallel processing units into one or more compute clusters including a corresponding number of communication rings based on a specified compute parameter; and
computing a function on input data by one of the compute clusters using a parallel communication ring algorithm.

13. The compute method according to claim 12, wherein the specified compute parameter comprises a number of parallel processing units of a given compute cluster.

14. The compute method according to claim 12, wherein the specified compute parameter comprises an amount of compute processing bandwidth.

15. The compute method according to claim 12, wherein the set of parallel processing units comprises eight parallel processing units organized in two subsets of four parallel processing units including two bi-directional communication links between each set of nearest neighbors of parallel processing units in each subset, one bi-directional communication link between each set of farthest neighbors of parallel processing units in each subset, and two bi-directional communication links between corresponding parallel processing units of the two subsets of parallel processing units.

16. The compute method according to claim 15, wherein configuring communication links of the set of parallel processing units into one or more compute clusters comprises configuring the bi-directional communication links into three parallel communication rings coupling the eight parallel processing units as one compute cluster.

17. The compute method according to claim 16, further comprising dividing the input data into six groups and loading respective pairs of the groups of data into respective parallel processing units.

18. The compute method according to claim 15, wherein configuring communication links of the set of parallel processing units into one or more compute clusters comprises configuring the bi-directional communication links into sets of two parallel communication rings coupling each respective subset of four parallel processing units as one or more respective compute clusters.

19. The compute method according to claim 18, further comprising dividing the input data into four groups and loading respective pairs of the groups of data into respective parallel processing units of a given compute cluster of four parallel processing units.

20. The compute method according to claim 15, wherein configuring communication links of the set of parallel processing units into one or more compute clusters comprises configuring the bi-directional communication links into at least one sets of one communication ring coupling each respective subset of two parallel processing units as one or more respective compute clusters.
